(19) United States
(12) Patent Application Publication
(10) Pub. No.: US 2008/0225022 A1
(43) Pub. Date: Sep. 18, 2008

(54) ORGANIC LIGHT EMITTING DISPLAY, AND DRIVING METHOD THEREOF

(76) Inventor: Keum-nam Kim, Suwon-si (KR)

Correspondence Address: CHRISTIE, PARKER & HALE, LLP, PO BOX 7068, PASADENA, CA, 91109-7068, US

(21) Appl. No.: 12/024,903

(22) Filed: Feb. 1, 2008

(30) Foreign Application Priority Data
Mar. 15, 2007 (KR) 10-2007-0025562

(51) Int. Cl. G06F 3/038; G09G 3/30

(52) U.S. Cl. 345/204; 345/80

(57) ABSTRACT

An organic light emitting display and a method for driving the same, which may shorten a charge time of a data signal in a pixel. A display region includes a pixel for receiving a data signal, a scan signal, an emission control signal, and drive voltages and for operating in response thereto. A data driver generates and transfers the data signal. The data signal is has an over drive period and a gradation expression period, and the data signal has a voltage during the over drive period higher than that during the gradation expression period. A scan driver generates and transfers the scan signal and the emission control signal through a scan line.

### CROSS-REFERENCE TO RELATED APPLICATION

This application claims priority to and the benefit of Korean Patent Application No. 10-2007-0025562, filed on Mar. 15, 2007, in the Korean Intellectual Property Office, the entire content of which is incorporated herein by reference.

### BACKGROUND

1. Field of the Invention

The present invention relates to an organic light emitting display, and a method for driving the same.

2. Discussion of Related Art

Recently, various flat panel displays have been developed with reduced weight and volume, which have been disadvantages of cathode ray tubes (CRT). In particular, an organic light emitting display device having excellent emission efficiency, luminance, viewing angle, and high speed response, has been highlighted.

An organic light emitting display displays images using a plurality of organic light emitting diodes (OLED). The OLED includes an anode electrode, a cathode electrode, and an organic emission layer. The organic emission layer is disposed between the anode electrode and the cathode electrode, and emits light from a combination of electrons and holes.

When there is a large electric current flowing through the OLED, the organic light emitting display expresses high luminance. In contrast to this, when there is little electric current flowing through the organic light emitting diode, the organic light emitting light emitting display expresses low luminance. In the aforementioned manner, the organic light emitting display controls an amount of an electric current flowing through the OLED to express gradations in luminance.

FIG. 1 is a schematic diagram showing a pixel circuit of a conventional organic light emitting display. FIG. 2 is a timing diagram of signals inputted to the pixel circuit shown in FIG. 1. With reference to FIG. 1 and FIG. 2, the conventional pixel circuit includes a first transistor T1, a second transistor T2, a third transistor T3, a fourth transistor T4, a fifth transistor M5, a sixth transistor T6, a capacitor Cst, and an organic light emitting diode OLED.

A source of the first transistor T1 is coupled to a first node N1, a drain thereof is coupled to a second node N2, and a gate thereof is coupled to a third node N3. The first transistor T1 controls an amount of an electric current flowing from the first node N1 to the second node N2.

A source of the second transistor T2 is coupled to a data line Dm, a drain thereof is coupled to the first node N1, and a gate thereof is coupled to a scan line Sn. The second transistor T2 is turned on/off according to a scan signal sn supplied through the scan line Sn, and selectively transfers a data signal supplied by the data line Dm, to the first node N1.

A source of the third transistor T3 is coupled to the second node N2, a drain thereof is coupled to the third node N3, and a gate thereof is coupled to the scan line Sn. The third transistor T3 selectively connects the second node N2 to the third node N3 in order to diode-connect the first transistor T1.

A source of the fourth transistor T4 is coupled to a power supply for transferring an initialization voltage V_{INIT}, a drain thereof is coupled to a first electrode of the capacitor Cst, and a gate thereof is coupled to a previous scan line Sn−1. The fourth transistor T4 initializes the capacitor Cst with the initialization voltage.

A source of the fifth transistor T5 is coupled to a first power supply line ELVDD, a drain thereof is coupled to the first node N1, and a gate thereof is coupled to an emission control line En. The fifth transistor T5 is turned on/off according to an emission control signal en supplied through the emission control line En to transfer a voltage of the first power supply line ELVDD to the first node N1.

A source of the sixth transistor T6 is coupled to the second node N2, a drain thereof is coupled to an anode electrode of the organic light emitting diode OLED, and a gate thereof is coupled to the emission control line En. The sixth transistor T6 performs on/off operations according to the emission control signal en supplied through the emission control line En, to switch an electric current from the first node N1 to the second node N2, to the organic light emitting diode OLED.

A first electrode of the capacitor Cst is coupled to the drain of the fourth transistor T4, and a second electrode thereof is coupled to the first power supply line ELVDD. The capacitor Cst maintains a voltage of the third node N3, namely, a gate voltage of the first transistor T1.

The organic light emitting diode OLED includes an anode electrode, a cathode electrode, and an emission layer. The emission layer is formed between the anode electrode and the cathode electrode. When an electric current flows through the emission layer, an intensity of emitting light is determined corresponding to an amount of the flowing electric current.

In the pixel having a construction mentioned above, the capacitor Cst is initialized with a previous scan signal sn−1 supplied through the previous scan line Sn−1, and the pixel receives a data signal dm according to the scan signal sn supplied through the scan line Sn. Namely, when the scan signal sn is in a low state, the data signal dm is transferred to a first electrode of the capacitor Cst, so that the capacitor Cst is charged with a voltage corresponding to the data signal dm. Further, when either of a previous scan signal sn−1 supplied through the previous scan line Sn−1 or a scan signal sn supplied through the scan line Sn is in a low state, an emission control signal en transferred through the emission control line En becomes a high state. Accordingly, when the scan signal sn is transferred to the pixel, the fifth transistor T5 and the sixth transistor T6 are turned off, so that an electric current does not flow through the organic light emitting diode OLED. In contrast to this, when the fifth transistor T5 and the sixth transistor T6 are turned on, an electric current flows through the organic light emitting diode OLED corresponding to a voltage stored in the capacitor Cst.

Here, so as to transfer the data signal dm to the first electrode of the capacitor Cst, the third transistor T3 is turned on according to the scan signal sn, thereby diode-connecting the first transistor T1. Accordingly, the data signal dm transferred to the first node N1 is provided to the first electrode of the capacitor Cst through the first transistor T1, with the result that the capacitor Cst is charged with a voltage corresponding to the data signal dm.

However, because the data signal dm is transferred to the first electrode of the capacitor Cst through the first transistor T1 being diode-coupled, a charge time of the data signal dm is delayed by the diode.

In particular, as the organic light emitting display is becoming larger in size, and a time period of one frame is shorter, a transfer time available for a data signal to be provided to a pixel is shortened. Accordingly, the problem associated with the delay in the charge time of the data signal in the pixel is increasingly pronounced.

### SUMMARY OF THE INVENTION

Accordingly, it is an aspect of various embodiments of the present invention to provide an organic light emitting display, and a method for driving the same, which may shorten a charge time of a data signal in a pixel.

The foregoing and/or other aspects of various embodiments of the present invention are achieved by providing an organic light emitting display including a display region, which has a pixel for receiving a data signal, a scan signal, an emission control signal, and drive voltages. The pixel operates in response to these signals. The display region further includes a data driver for generating and transferring the data signal, and dividing the data signal into an over drive period and a gradation expression period, where the over drive period has a voltage higher than that of the gradation expression period. A scan driver generates and transfers the scan signal and the emission control signal through a scan line.

According to a second aspect of the present invention, there is provided a method for driving an organic light emitting display emitting light in response to a data signal, a scan signal, and an emission control signal. The method includes generating and transferring the data signal, where the data signal includes an over drive period and a gradation expression period, and the data signal has a higher voltage during the over drive period than that during the gradation expression period. The method further includes storing a voltage of the gradation expression period to generate an electric current corresponding to the voltage of the gradation expression period.

### BRIEF DESCRIPTION OF THE DRAWINGS

These and/or other embodiments and features of the invention will become apparent and more readily appreciated from the following description of the certain exemplary embodiments, taken in conjunction with the accompanying drawings of which:

FIG. 1 is a schematic circuit diagram showing a pixel circuit of a conventional organic light emitting display;

FIG. 2 is a timing diagram of signals inputted to the pixel shown in FIG. 1.

FIG. 3 is a block diagram showing a construction of an organic light emitting display according to an embodiment of the present invention;

FIG. 4 is a timing diagram showing a waveform of signals inputted to the pixel of the organic light emitting display shown in FIG. 3;

FIG. 5 is a schematic circuit diagram showing a pixel circuit in the organic light emitting display according to a first embodiment of the present invention;

FIG. 6 is a schematic circuit diagram showing a pixel circuit in the organic light emitting display according to a second embodiment of the present invention; and

FIG. 7 is a schematic circuit diagram showing a pixel circuit in the organic light emitting display according to a third embodiment of the present invention.

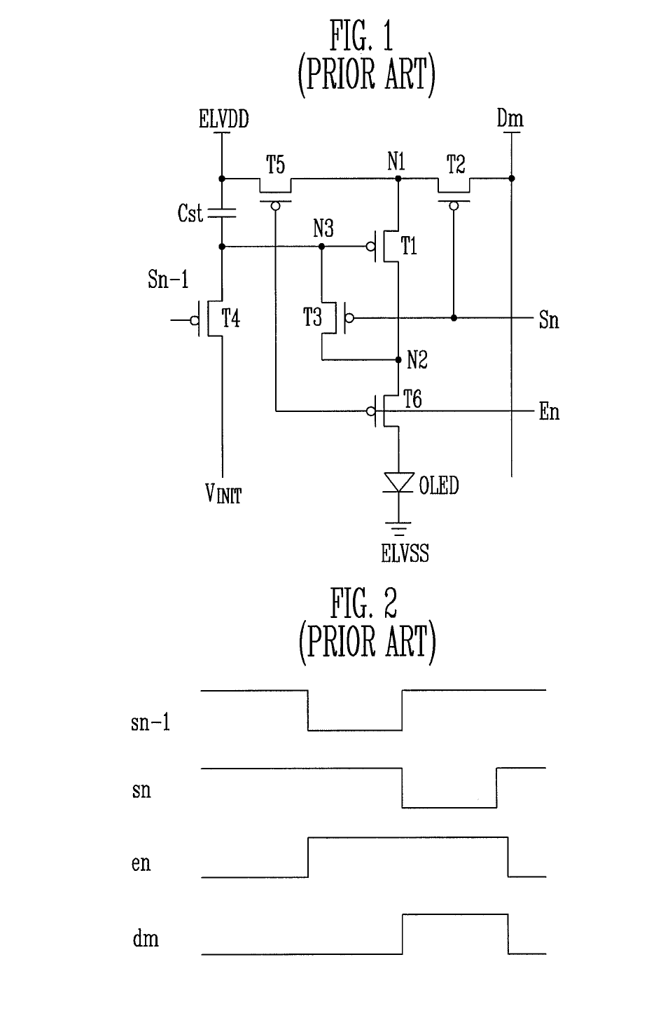

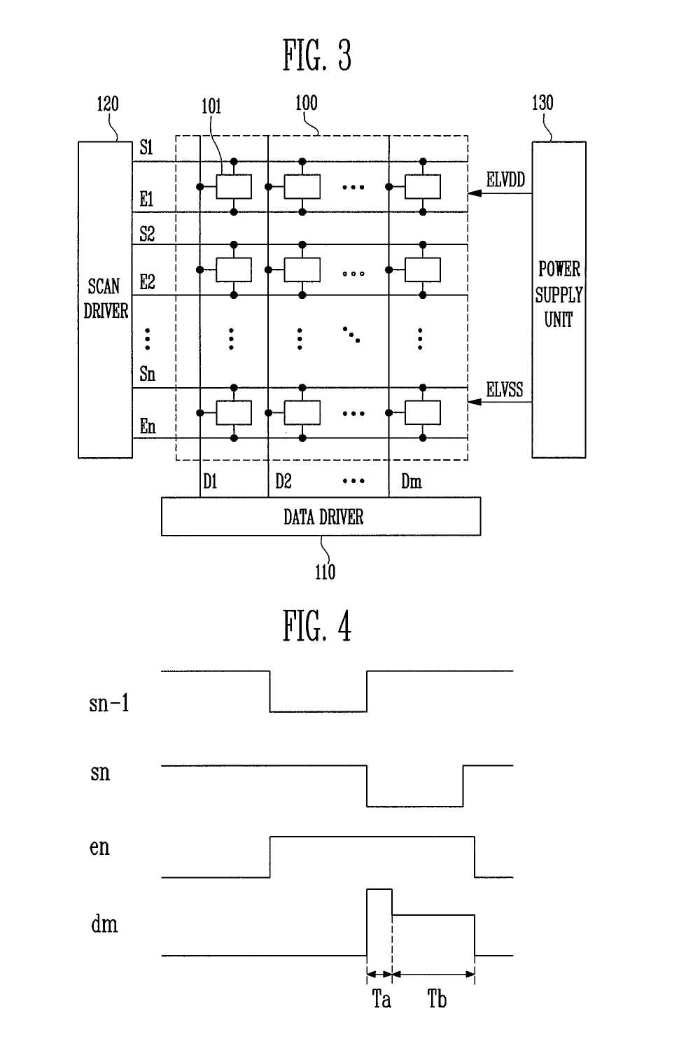

### DETAILED DESCRIPTION OF EMBODIMENTS

Hereinafter, certain exemplary embodiments according to the present invention will be described with reference to the accompanying drawings. Here, when a first element is described as being connected or coupled to a second element, the first element may not only be directly connected or coupled to the second element but may also be indirectly connected or coupled to the second element via a third element. Further, some elements that are not essential to the complete understanding of the invention are omitted for clarity. Also, like reference numerals refer to like elements throughout.

FIG. 3 is a block diagram showing a construction of an organic light emitting display according to an embodiment of the present invention. With reference to FIG. 3, the organic light emitting display according to an embodiment of the present invention includes a display region 100, a data driver 110, a scan driver 120 and a power supply unit 130.

A plurality of pixels 101 are arranged at the display region 100. Each of the pixels 101 includes an organic light emitting diode (not shown). N scan lines S1, S2, S3, . . . , Sn−1, Sn and m data lines D1, D2, . . . , Dm−1, and Dm are arranged in rows and columns at the display region 100, respectively. The N scan lines S1, S2, S3, . . . , Sn−1, Sn transfer a scan signal sn, and the m data lines D1, D2, . . . , Dm−1, and Dm transfer a data signal dm. The display region 100 operates using power received from the first power source ELVDD and the second power source ELVSS. Accordingly, in the display region 100, an organic light emitting diode emits light according the scan signal sn, the data signal dm, the first power source ELVDD, and the second power source ELVSS to display images.

The data driver 110 applies the data signal dm to the display region 100. The data driver 110 receives video data having red, green, and blue components, and generates the data signal dm. The data driver 110 is coupled to the data lines D1, D2, . . . , Dm−1, Dm, and provides the generated data signal dm to the display region 100.

The scan driver 120 applies the scan signal sn to the display region 100. The scan driver 120 is coupled to scan lines S1, S2, . . . , Sn−1, Sn, and transfers the scan signal sn to a row of the display region 100. A data signal dm from the data driver 110 is transferred to the pixel 101 to which the scan signal sn is transferred.

A data signal dm from the data driver 110 is applied to the row of the display region 100 to which the scan signal sn is transferred, so that an electric current corresponding to the data signal dm flows through respective pixels.

Further, the scan signal sn causes an initialization signal to be transferred to a storage capacitor. Accordingly, the data signal dm stored in the pixel 101 is initialized with the initialization signal V_{INIT}, thereby preventing the stored data signal dm from influencing a newly transferred data signal dm.

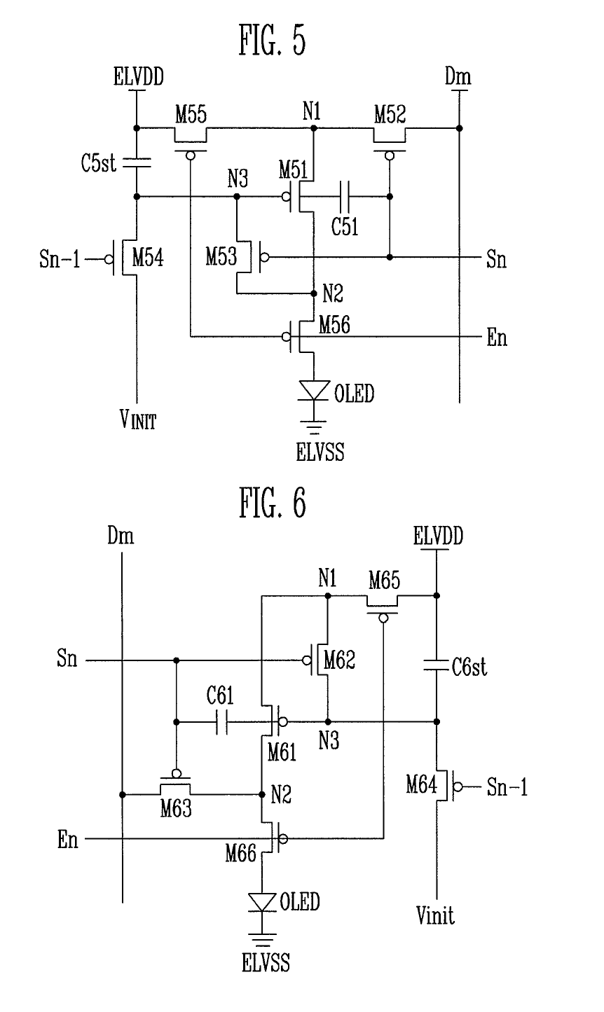

FIG. 4 is a timing diagram showing waveforms of signals inputted to the pixel of the organic light emitting display shown in FIG. 3. With reference to FIG. 4, scan signals sn and sn−1, an emission control signal en, and a data signal dm are inputted to the pixels 101. Respective pixels 101 are initialized with a previous scan signal sn−1 of a previous scan line Sn−1. After the pixels 101 are initialized, a first transistor is diode-coupled by the scan signal sn, generating an electric current corresponding to the data signal dm. Because the first transistor is diode-coupled, an amount of a flowing electric current is reduced. Accordingly, it takes a relatively long time to charge the first capacitor with a voltage corresponding to the data signal dm. Here, the first capacitor stores the voltage corresponding to the data signal dm. In order to address this problem, the data signal dm includes an over drive time period Ta and a gradation expression time period Tb. This is because a large voltage causes a charge time of the first capacitor to be rapid. In a first state in which a data signal is transferred, a voltage higher than that required to express the desired gradation is transferred during the over drive time period Ta. Next, at the end of the over drive time period Ta, during the gradation expression time period Tb, the data signal voltage dm is reduced to a value capable of expressing a normal gradation, so that the first electrode of the first capacitor may output a voltage corresponding to a gradation voltage.

The time during which an electric current generated in the first transistor is transferred to the organic light emitting diode is determined by the emission control signal en.

FIG. 5 is a circuit diagram showing a pixel in the organic light emitting display according to a first embodiment of the present invention. With reference to FIG. 5, the pixel according to a first embodiment of the present invention includes a first transistor M51, a second transistor M52, a third transistor M53, a fourth transistor M54, a fifth transistor M55, a sixth transistor M56, a first capacitor C5st, a second capacitor C51, and an organic light emitting diode OLED.

A source of the first transistor M51 is coupled to a first node N1, a drain thereof is coupled to a second node N2, and a gate thereof is coupled to a third node N3. The first transistor M51 controls an amount of an electric current flowing from the first node N1 to the second node N2.

A source of the second transistor M52 is coupled to a data line Dm, a drain thereof is coupled to the first node N1, and a gate thereof is coupled to a scan line Sn. The second transistor M52 is turned on/off according to a scan signal sn supplied through the scan line Sn, and selectively transfers a data signal dm from the data line Dm, to the first node N1.

A source of the third transistor M53 is coupled to the second node N2, a drain thereof is coupled to the third node N3, and a gate thereof is coupled to the scan line Sn. The third transistor M53 performs on/off operations by a scan signal sn to selectively provide the same voltage to a gate and a drain of the first transistor M51. Accordingly, the first transistor M51 is diode-coupled.

A source of the fourth transistor M54 is coupled to an initialization power supply line V_{INIT} for transferring an initialization voltage, a drain thereof is coupled to the third node N3, and a gate thereof is coupled to a previous scan line Sn−1. The fourth transistor M54 is turned on/off according to a previous scan signal sn−1 of the previous scan line Sn−1 to initialize the first capacitor C5st.

A source of the fifth transistor M55 is coupled to the first node N1, a drain thereof is coupled to the first power supply line ELVDD for transferring a first power source, and a gate thereof is coupled to an emission control line En. The fifth transistor M55 is turned on/off according to an emission control signal supplied through the emission control line En to transfer a voltage of the first power supply line ELVDD to the first node N1.

A source of the sixth transistor M56 is coupled to the second node N2, a drain thereof is coupled to an anode electrode of the organic light emitting diode OLED, and a gate thereof is coupled to the emission control line En. The sixth transistor M56 performs on/off operations according to the emission control signal en supplied through the emission control line En, to switch an electric current from the first node N1 to the second node N2, to the organic light emitting diode OLED.

A first electrode of the capacitor C5st is coupled to the third node N3, and a second electrode thereof is coupled to the first power supply line ELVDD. The capacitor C5st maintains a voltage of the third node N3.

A first electrode of the second capacitor C51 is coupled to a gate of the second transistor M52, and a second electrode thereof is coupled to the third node N3. When the scan signal sn changes from a low state to a high state, a voltage in the first electrode of the second capacitor C51 is increased. This causes a voltage of the third node N3 to be increased. Accordingly, where a pixel expresses black images, if the data signal does not output a voltage capable of expressing the black images, the voltage of the third node N3 is increased when the scan signal sn changes from a low state to a high state. Consequently, a gate voltage of the first transistor M51 is increased, so that the pixel may express the black images.

The organic light emitting diode OLED includes an anode electrode, a cathode electrode, and an emission layer. The emission layer is formed between the anode electrode and the cathode electrode. When an electric current flows through the emission layer, it emits light corresponding to an amount of the flowing electric current. An anode electrode of the organic light emitting diode OLED is coupled to the drain of the sixth transistor M56, and a cathode electrode thereof is coupled to the second power supply ELVSS.

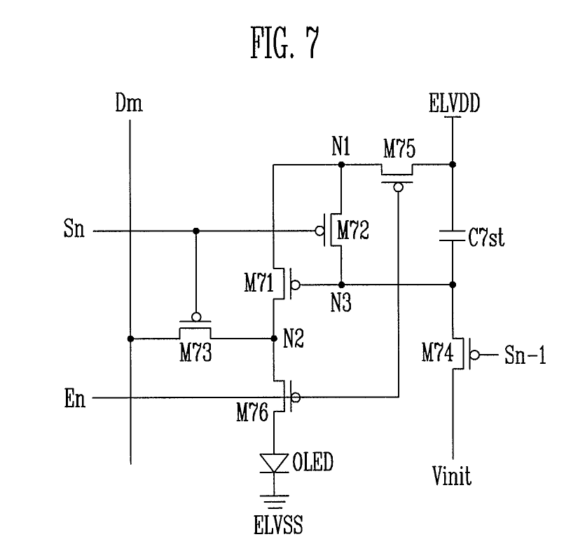

FIG. 6 is a circuit diagram showing a pixel in the organic light emitting display according to a second embodiment of the present invention. Referring to FIG. 6, the pixel according to the second embodiment of the present invention includes a first transistor M61, a second transistor M62, a third transistor M63, a fourth transistor M64, a fifth transistor M65, a sixth transistor M66, a first capacitor C6st, a second capacitor C61, and an organic light emitting diode OLED.

A source of the first transistor M61 is coupled to a first node N1, a drain thereof is coupled to a second node N2, and a gate thereof is coupled to a third node N3. The first transistor M61 controls an amount of an electric current flowing from the first node N1 to the second node N2.

A source of the second transistor M62 is coupled to the third node N3, a drain thereof is coupled to the first node N1, and a gate thereof is coupled to a scan line Sn. The second transistor M62 is turned on/off according to a scan signal sn supplied through the scan line Sn, and selectively causes a gate voltage and a source voltage of the first transistor M61 to have the same value, so that the first transistor M61 is diode-coupled.

A source of the third transistor M63 is coupled to the data line Dm, a drain thereof is coupled to the second node N2, and a gate thereof is coupled to the scan line Sn. The third transistor M63 performs on/off operations by a scan signal sn to selectively provide a data signal dm to the second node N2. When the data signal dm is transferred to the second node N2, the first transistor M61 is diode-coupled by the second transistor M62, so that the data signal dm transferred to the second node N2 is provided to the third node N3 through the first transistor M61.

A source of the fourth transistor M64 is coupled to an initialization power supply line Vinit for transferring an initialization voltage, a drain thereof is coupled to the third node N3, and a gate thereof is coupled to a previous scan line Sn−1. The fourth transistor M64 is turned on/off according to a previous scan signal sn−1 of the previous scan line Sn−1 to initialize the first capacitor C6st.

A source of the fifth transistor M65 is coupled to the first node N1, a drain thereof is coupled to the first power supply line ELVDD for transferring a first power source, and a gate thereof is coupled to an emission control line En. The fifth transistor M65 is turned on/off according to an emission control signal en supplied through the emission control line En to transfer a voltage of the first power supply line ELVDD to the first node N1.

A source of the sixth transistor M66 is coupled to the second node N2, a drain thereof is coupled to an anode electrode of the organic light emitting diode OLED, and a gate thereof is coupled to the emission control line En. The sixth transistor M66 performs on/off operations according to the emission control signal en supplied through the emission control line En, to switch an electric current from the first node N1 to the second node N2, to the organic light emitting diode OLED.

A first electrode of the first capacitor C6st is coupled to the third node N3, and a second electrode thereof is coupled to the first power supply line ELVDD. The capacitor C6st maintains a voltage of the third node N3.

A first electrode of the second capacitor C61 is coupled to a gate of the second transistor M62, and a second electrode thereof is coupled to the third node N3. When the scan signal sn changes from a low state to a high state, a voltage in the first electrode of the second capacitor C61 is increased. This causes a voltage of the third node N3 to be increased. Accordingly, where a pixel expresses black images, if the data signal dm does not output a voltage capable of expressing the black images, the voltage of the third node N3 is increased when the scan signal sn changes from a low state to a high state. Consequently, a gate voltage of the first transistor M61 is increased, so that the pixel may express the black images.

The organic light emitting diode OLED includes an anode electrode, a cathode electrode, and an emission layer. The emission layer is formed between the anode electrode and the cathode electrode. When an electric current flows through the emission layer, it emits light corresponding to an amount of the flowing electric current. An anode electrode of the organic light emitting diode OLED is coupled to the drain of the sixth transistor M66, and a cathode electrode thereof is coupled to the second power supply ELVSS.

FIG. 7 is a circuit diagram showing a third embodiment of a pixel in the organic light emitting display according to the present invention.

Referring to FIG. 7, the pixel according to the third embodiment of the present invention includes a first transistor M71, a second transistor M72, a third transistor M73, a fourth transistor M74, a fifth transistor M75, a sixth transistor M76, a capacitor C7st, and an organic light emitting diode OLED.

A source of the first transistor M71 is coupled to a first node N1, a drain thereof is coupled to a second node N2, and a gate thereof is coupled to a third node N3. The first transistor T1 controls an amount of an electric current flowing from the first node N1 to the second node N2.

A source of the second transistor M72 is coupled to the third node N3, a drain thereof is coupled to the first node N1, and a gate thereof is coupled to a scan line Sn. The second transistor M72 is turned on/off according to a scan signal sn supplied through the scan line Sn, and selectively causes a gate voltage and a source voltage of the first transistor M71 to have the same value, so that the first transistor M71 is diode-coupled.

A source of the third transistor M73 is coupled to the data line Dm, a drain thereof is coupled to the second node N2, and a gate thereof is coupled to the scan line Sn. The third transistor T3 performs on/off operations by a scan signal sn to selectively provide a data signal dm to the second node N2. When the data signal is transferred to the second node N2, the first transistor M71 is diode-coupled by the second transistor M72, so that the data signal dm transferred to the second node N2 is provided to the third node N3 through the first transistor M71.

A source of the fourth transistor M74 is coupled to an initialization power supply line Vinit for transferring an initialization voltage, a drain thereof is coupled to the third node N3, and a gate thereof is coupled to a previous scan line Sn−1. The fourth transistor M74 is turned on/off according to a previous scan signal sn−1 of the previous scan line Sn−1 to initialize the capacitor C7st.

A source of the fifth transistor M75 is coupled to the first node N1, a drain thereof is coupled to the first power supply line ELVDD for transferring a first power source, and a gate thereof is coupled to an emission control line En. The fifth transistor M75 is turned on/off according to an emission control signal en supplied through the emission control line En to transfer a voltage of the first power supply line ELVDD to the first node N1.

A source of the sixth transistor M76 is coupled to the second node N2, a drain thereof is coupled to an anode electrode of the organic light emitting diode OLED, and a gate thereof is coupled to the emission control line En. The sixth transistor M76 performs on/off operations according to the emission control signal en supplied through the emission control line En, to switch an electric current from the first node N1 to the second node N2, to the organic light emitting diode OLED.

A first electrode of the first capacitor C7st is coupled to the third node N3, and a second electrode thereof is coupled to the first power supply line ELVDD. The capacitor C7st maintains a voltage of the third node N3.

The organic light emitting diode OLED includes an anode electrode, a cathode electrode, and an emission layer. The emission layer is formed between the anode electrode and the cathode electrode. When an electric current flows through the emission layer, it emits light corresponding to an amount of the flowing electric current. An anode electrode of the organic light emitting diode OLED is coupled to the drain of the sixth transistor M76, and a cathode electrode thereof is coupled to the second power supply ELVSS.

As mentioned above, according to a pixel, an organic light emitting display, and a method for driving an organic light emitting display using the pixel of various embodiments of the present invention, a pixel is charged with a voltage while sinking a current (e.g., a predetermined current), and a luminance is expressed while controlling an emission time of a pixel charged with the voltage. Here, because each pixel is charged with a voltage using a current that may be predetermined, the pixel can be charged with a desired voltage essentially irrespective of threshold voltages and mobility of transistors included in the pixels. This causes an image of a desired luminance to be displayed.

Although exemplary embodiments of the present invention have been shown and described, it will be appreciated by those skilled in the art that changes might be made in these embodiments without departing from the principles and spirit of the invention, the scope of which is defined in the claims and their equivalents.

What is claimed is:

1. An organic light emitting display, comprising:
a display region comprising a plurality of pixels, wherein a first pixel among the plurality of pixels is adapted to receive a data signal, a scan signal, an emission control signal, and drive voltages, and to operate in response thereto;
a data driver adapted to generate and transfer the data signal, wherein the data signal comprises an over drive period and a gradation expression period, and wherein the data driver is adapted to generate a first voltage during the over drive period and a second voltage during the gradation expression period, and wherein the first voltage during the over drive period is higher than the second voltage during the gradation expression period; and
a scan driver adapted to generate and transfer the scan signal through scan lines and the emission control signal through emission control lines.

2. The organic light emitting display as claimed in claim 1, wherein the first pixel comprises:
a first transistor adapted to receive at its gate a voltage corresponding to the data signal, and to generate an electric current;
a second transistor adapted to diode-connect the first transistor to cause the data signal to be transferred to the gate of the first transistor; and
a capacitor adapted to maintain a voltage of the gate of the first transistor.

3. The organic light emitting display as claimed in claim 1, wherein the first pixel comprises:
an organic light emitting diode;
a first transistor comprising a first electrode coupled to a first node, a second electrode coupled to a second node, and a third electrode coupled to a third node;
a second transistor comprising a first electrode coupled to a data line, a second electrode coupled to the first node, and a third electrode coupled to a first scan line among the scan lines;
a third transistor comprising a first electrode coupled to the second node, a second electrode coupled to the third node, and a third electrode coupled to the first scan line;
a fourth transistor comprising a first electrode coupled to an initialization signal line, a second electrode coupled to the third node, and a third electrode coupled to a previous scan line among the scan lines;
a fifth transistor comprising a first electrode coupled to a first power supply line, a second electrode coupled to the first node, and a third electrode coupled to a first emission control line among the emission control lines;
a sixth transistor comprising a first electrode coupled to the second node, a second electrode coupled to the organic light emitting diode, and a third electrode coupled to the first emission control line;
a first capacitor comprising a first electrode coupled to the third node and a second electrode coupled to the first power supply line; and
a second capacitor comprising a first electrode coupled to the first scan line and a second electrode coupled to the third node.

4. The organic light emitting display as claimed in claim 1, wherein the first pixel comprises:
an organic light emitting diode;
a first transistor comprising a first electrode coupled to a first node, a second electrode coupled to a second node, and a third electrode coupled to a third node;
a second transistor comprising a first electrode coupled to the first node, a second electrode coupled to the third node, and a third electrode coupled to a first scan line among the scan lines;
a third transistor comprising a first electrode coupled to a data line, a second electrode coupled to the second node, and a third electrode coupled to the first scan line;
a fourth transistor comprising a first electrode coupled to an initialization signal line, a second electrode coupled to the third node, and a third electrode coupled to a previous scan line among the scan lines;
a fifth transistor comprising a first electrode coupled to a first power supply line, a second electrode coupled to the first node, and a third electrode coupled to a first emission control line among the emission control lines;
a sixth transistor comprising a first electrode coupled to the second node, a second electrode coupled to the organic light emitting diode, and a third electrode coupled to the first emission control line;
a first capacitor comprising a first electrode coupled to the third node and a second electrode coupled to the first power supply line; and
a second capacitor comprising a first electrode coupled to the first scan line and a second electrode coupled to the third node.

5. The organic light emitting display as claimed in claim 1, wherein the first pixel comprises:
an organic light emitting diode;
a first transistor comprising a first electrode coupled to a first node, a second electrode coupled to a second node, and a third electrode coupled to a third node;
a second transistor comprising a first electrode coupled to the first node, a second electrode coupled to the third node, and a third electrode coupled to a first scan line among the scan lines;
a third transistor comprising a first electrode coupled to a data line, a second electrode coupled to the second node, and a third electrode coupled to the first scan line;
a fourth transistor comprising a first electrode coupled to an initialization signal line, a second electrode coupled to the third node, and a third electrode coupled to a previous scan line among the scan lines;
a fifth transistor comprising a first electrode coupled to a first power supply line, a second electrode coupled to the first node, and a third electrode coupled to a first emission control line among the emission control lines;
a sixth transistor comprising a first electrode coupled to the second node, a second electrode coupled to the organic light emitting diode, and a third electrode coupled to the first emission control line;
a capacitor comprising a first electrode coupled to the third node and a second electrode coupled to the first power supply line.

6. The organic light emitting display as claimed in claim 2, wherein the first voltage during the over drive period is adapted to charge the capacitor faster than the second voltage during the gradation expression period.

7. The organic light emitting display as claimed in claim 2, wherein the capacitor is adapted to store a voltage corresponding to the second voltage during the gradation expression period.

8. A method for driving an organic light emitting display emitting light in response to a data signal, a scan signal, and an emission control signal, the method comprising:
generating the data signal, wherein the data signal comprises an over drive period and a gradation expression period, and the data signal has a higher voltage during the over drive period than a voltage of the data signal during the gradation expression period; and
storing the voltage of the gradation expression period to generate an electric current corresponding to the voltage of the gradation expression period.

9. A method for driving an organic light emitting display having a display region with a plurality of pixels, the method comprising:
generating a data signal, a first scan signal, a second scan signal, and an emission control signal to operate a pixel among the plurality of pixels, wherein the data signal has an over drive voltage during an over drive period and a gradation expression voltage during a gradation expression period, and wherein the over drive voltage is larger than the gradation expression voltage;
setting the emission control signal to a voltage such that an organic light emitting diode in the pixel is off;
initializing a voltage of a storage capacitor to an initialization voltage by setting the first scan signal low;
charging the storage capacitor using a charging current that corresponds to the data signal, by setting the second scan signal low, such that the charging current during the over drive period is higher than the charging current during the gradation expression period, and such that a voltage of the storage capacitor at the end of the gradation expression period corresponds to the gradation expression voltage;
setting the emission control signal to a voltage such that the organic light emitting diode is on; and
generating a current through the organic light emitting diode corresponding to the gradation expression voltage stored in the storage capacitor.
